(19) United States
(12) Patent Application Publication
(10) Pub. No.: US 2008/0018739 A1
(43) Pub. Date: Jan. 24, 2008

(54) Moving picture play system, method and medium thereof

(75) Inventors: Eui Hyeon Hwang, Goyang-si (KR); Jin Guk Jeong, Yongin-si (KR); Ji Yeun Kim, Seoul (KR); Sang Kyun Kim, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/586,605

(22) Filed: Oct. 26, 2006

(30) Foreign Application Priority Data
Jul. 18, 2006 (KR) 10-2006-0066743

(51) Int. Cl. H04N 7/18

(52) U.S. Cl. 348/148

(57) ABSTRACT

A moving picture play system, method and medium which includes determining whether a driver of a vehicle is unable to view moving picture data, summarizing moving picture data when it is determined the driver of the vehicle is unable to view the moving picture data, and playing the summarized moving picture data or recorded moving picture data when it is determined the driver of the vehicle is able to view moving picture data.

### CROSS-REFERENCE TO RELATED APPLICATIONS

This application claims the benefit of Korean Patent Application No. 10-2006-0066743, filed on Jul. 18, 2006, in the Korean Intellectual Property Office, the disclosure of which is incorporated herein by reference.

### BACKGROUND OF THE INVENTION

1. Field of the Invention

The present invention relates to a moving picture playing method used in a vehicle and a system using the method. More particularly, the present invention relates to a method which can summarize a moving picture when a driver of the vehicle is unable to view the moving picture, and play the summarized moving picture when the driver of the vehicle is able to view the moving picture, and a system using the method.

2. Description of the Related Art

A conventional system for playing a moving picture in a mobile environment, such as a location free TV as released from SONY Electronics Inc., focuses on playing in a mobile terminal, moving picture contents broadcast over the airwaves or moving picture contents personally stored using a wireless communication. Further, in the conventional art, with regards to summarizing a moving picture, the focus is only on the summarizing, (i.e. how to properly summarize the moving picture), and there is no consideration regarding a particular environment such as driving a vehicle. Also, storing the moving picture may be difficult and high performance may not be provided in the mobile environment that has a limited power source and a processor having comparatively low specifications and features.

Since a mobile device used in a vehicle is relatively insensitive to a power source problem, there is no problem of storing the moving picture, and a processor capable of high performance may be provided compared to that of a personal mobile device. Also, the mobile device used in the vehicle is comparatively free from restrictions in weight and size in comparison to the personal mobile device. On the other hand, viewing the moving picture while driving may cause a serious social problem, since viewing the moving picture would take the driver's attention away from driving. As a generation of one car per person has arrived, and wireless communication technology for viewing a mobile moving picture has been achieved, viewing of a moving picture while driving may become a serious social issue.

Accordingly, a safe method and system which can play a moving picture while the driver of the vehicle is driving the vehicle is necessary.

### SUMMARY OF THE INVENTION

Accordingly, it is an aspect of the present invention to provide a method and a system using the method which can summarize received broadcast data when a driver of a vehicle is unable to view a moving picture, and play the summarized broadcast data when the driver of the vehicle is able to view the moving picture.

It is another aspect of the present invention to provide a method and a system using the method which can play a summarized a moving picture only under safe viewing circumstances since it is determined whether a driver of a vehicle is able to view moving picture data by detecting a speed and a movement of the vehicle.

It is yet another aspect of the present invention to provide a method and a system using the method, which can automatically play a moving picture by comparing a length of summarized broadcast data and recorded broadcast data with a reference value, when a driver of a vehicle is able to view the moving picture, and summarizing and recording received broadcast data when the driver of the vehicle is unable to view the moving picture.

Additional aspects and/or advantages of the invention will be set forth in part in the description which follows and, in part, will be apparent from the description, or may be learned by practice of the invention.

The foregoing and/or other aspects of the present invention are achieved by providing a moving picture playing method including determining whether a driver of a vehicle is unable to view moving picture data, summarizing moving picture data when it is determined the driver of the vehicle is unable to view the moving picture data, and playing the summarized moving picture data or recorded moving picture data when it is determined that the driver of the vehicle is able to view moving picture data.

Another aspect of the present invention is achieved by providing a system of playing a moving picture including a vehicle condition detection unit to detect a vehicle condition, a play unit to play broadcast data or moving picture data, a determination unit to determine whether a driver of the vehicle is unable to view the played broadcast data or moving picture data based on the detected vehicle condition, and a summary unit to summarize the received broadcast data or moving picture data, when it is determined that the driver of the vehicle is unable to view the moving picture.

### BRIEF DESCRIPTION OF THE DRAWINGS

These and/or other aspects and advantages of the present invention will become apparent and more readily appreciated from the following description of the embodiments taken in conjunction with the accompanying drawings of which:

FIG. 1 is a diagram illustrating a system of playing a moving picture according to an embodiment of the present invention;

FIG. 2 is a flowchart illustrating a moving picture playing method according to an embodiment of the present invention;

FIG. 3 is a flowchart illustrating an operation of generating a control signal corresponding to each mode, via the system shown in FIG. 1, according to an embodiment of the present invention;

FIG. 4 is a flowchart illustrating summarizing and recording operations when a driver is unable to view received broadcast data according to an embodiment of the present invention; and

FIG. 5 is a flowchart illustrating a playing operation of summarized broadcast data or recorded broadcast data according to an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

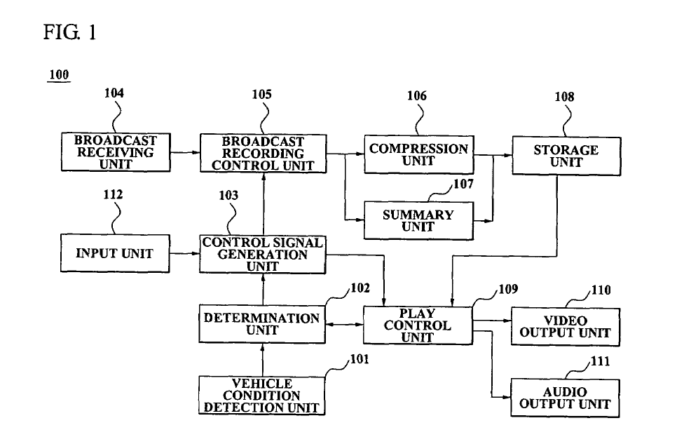

FIG. 1 is a diagram illustrating a moving picture play system according to an embodiment of the present invention.

Referring to FIG. 1, the moving picture playing system 100 checks a current system condition and initializes specified values to an initial condition in an operation of system initialization.

A vehicle condition detection unit 101 detects speed and/or movement of the vehicle. Specifically, the vehicle condition detection unit 101 detects the speed and/or movement of the vehicle via a global positioning system (GPS), a vehicle speedometer, a gyro sensor, and the like, the present invention is not limited hereto and any suitable speed and/or movement detector may be used.

When the speed and/or movement of the vehicle has been detected by the vehicle condition detection unit 101, a determination unit 102 determines whether a driver of the vehicle is unable to view the moving picture, based on the detected speed or movement of the vehicle.

Further, when the speed of the vehicle is detected via the vehicle condition detection unit 101, the determination unit 102 compares the detected speed of the vehicle with a first reference value, and when the detected speed of the vehicle is not less than the first reference value, the determination unit 102 determines the driver of the vehicle is unable to view the moving picture. In this embodiment of the present invention, the first reference value indicates criterion data for the speed of the vehicle, i.e. the speed of the vehicle which may determine the driver of the vehicle is unable to view moving picture data. Specifically, when the detected speed of the vehicle is not less than the first reference value, and when the driver of the vehicle keeps viewing the moving picture data, a likelihood of a vehicle accident increases, therefore it is determined that the driver is unable to view the moving picture data. For example, when the first reference value is set at 1 km/h, and when the determination unit 102 determines that the detected speed of the vehicle is greater than 1 km/h, it is then determined the driver is unable to view the moving picture data.

When the movement of the vehicle is detected via the vehicle condition detection unit 101, the determination unit 102 compares the movement of the vehicle with a second reference value, and when the detected movement of the vehicle is not less than the second reference value, it is determined the driver of the vehicle is unable to view the moving picture data. In this embodiment of the present invention, the second reference value indicates criterion data for the movement of the vehicle, for example, the movement of the vehicle which may determine the driver is unable to view the moving picture data even when the speed of the vehicle is less than the second reference value. For example, when a road the vehicle is being driven on is a curved road, and when the driver of the vehicle is careless in driving even though the speed of the vehicle on the curved road is comparatively lower than the speed of the vehicle on straight road, a likelihood of a vehicle accident increases, therefore, it is required to be determined that the driver of the vehicle is unable to view the moving picture data. Namely, when the detected movement of the vehicle is greater than the second reference value, and when the driver of the vehicle keeps viewing the moving picture, it is determined the driver of the vehicle is unable to view the moving picture.

A control signal generation unit 103 generates a control signal according to a broadcast receiving mode or a moving picture play mode.

According to an embodiment of the present invention, the control signal generation unit 103 generates the control signal with respect to how to process a received broadcast data, according to whether the driver of the vehicle is able to view the moving picture data in the broadcast receiving mode.

First, the control signal generation unit 103 control signals such as a screen shut off signal, a broadcast recording start signal, and a summary generation start signal, for the moving picture data in the broadcast receiving mode, when it is determined the driver of the vehicle is unable to view the received broadcast data. According to this embodiment of the present invention, the screen shut off signal is a type of a control signal to prevent a screen output for the received broadcast data, when it is determined the driver of the vehicle is unable to view the moving picture data. The broadcast recording start signal is a type of a control signal to start recording the received broadcast data, and the summary generation start signal is a type of a control signal to start generating a summary data for the received broadcast data.

Next, the control signal generation unit 103 generates control signals such as a recording stop signal, a summary play signal, and a screen connection signal, when it is determined the driver of the vehicle is able to view the received broadcast data. In this embodiment of the present invention, the recording stop signal is a type of a control signal to stop the recording of the received broadcast data, the summary play signal is a type of a signal to play summary data for the received broadcast data, and the screen connection signal is a type of a signal to deliver the shut-off screen for the received broadcast data.

Conversely, the control signal generation unit 103 generates a control signal corresponding to how to play the stored moving picture data in the moving picture play mode. For example, the control signal generation unit 103 generates a control signal corresponding to how to play the stored moving picture data in the moving picture play mode according to whether the driver of the vehicle is able to view the moving picture data in the broadcast receiving mode.

First, the control signal generation unit 103 generates control signals such as a screen shut off signal and a pause signal, when it is determined that the driver of the vehicle is unable to view the moving data. In this embodiment, the screen shut off signal is a type of a signal to prevent the moving picture data from being outputted on a display screen, and the pause signal is a type of a signal to pause the stored moving picture data to be played.

Next, the control signal generation unit 103 generates control signals, for example, a screen connection signal and a play signal, when it is determined that the driver of the vehicle is able to view the moving data. In this embodiment, the screen connection signal is a type of a control signal to connect the shut-off screen with respect to the moving picture data, and the play signal is a type of a control signal to continue playing of the moving picture data paused by the pause signal.

A broadcast receiving unit 104 receives broadcast data. The broadcast data comprises terrestrial broadcast data and/or satellite broadcast data, for example.

A broadcast recording control unit 105 delivers the broadcast data received by the broadcast receiving unit 104 to a compression unit 106 and/or a summary unit 107 (described in detail below), depending upon the control signals received.

The compression unit 106 compresses the received broadcast data when the received broadcast data is non-compressed data. Also, even when the received broadcast data is compressed data, the compression unit 106 compresses the received broadcast data according to other compression methods, depending on circumstances. The present invention is not limited to any particular type of compression method and may vary accordingly.

The summary unit 107 generates moving picture summary data by analyzing the received broadcast data. Specifically, when the received broadcast data is a soccer broadcast, the summary unit 107 generates moving picture summary data which is configured of only highlights, for example, a scoring scene, a free kick scene, a penalty kick scene and the like, by analyzing the received broadcast data. The present invention is not limited to any particular type of method for generating moving picture data and thus, various methods of generating various moving picture data may be applied to the generating of the moving picture summary data.

The storage unit 108 stores the moving picture data, the summarized broadcast data, and the moving picture summary data.

As described above, the moving picture playing system 100 may generate summary data for the received broadcast data or the played moving picture data, when the driver of the vehicle is unable to view the received broadcast data or the played moving picture data.

A play control unit 109 plays the moving picture summary data or the stored moving picture data according to the broadcast receiving mode or the moving picture play mode, when the driver of the vehicle is able to view the received broadcast data or the stored moving picture data. The play control unit 109 plays the received broadcast data when the driver of the vehicle is able to view the received broadcast data in the broadcast receiving mode, and the play control unit 109 plays the moving picture summary data that is generated, or the stored moving picture data which is stored when the driver of the vehicle is unable to view the received broadcast data, when the driver of the vehicle is able to view the received broadcast data in the moving picture play mode.

The play control unit 109 compares lengths between the broadcast data stored when the driver is unable to view the received broadcast data, and the summarized broadcast data generated when the driver is unable to view the received broadcast data, and depending upon a result of the comparison, subsequently plays the stored broadcast data or the summarized broadcast data.

According to an embodiment of the present invention, the play control unit 109 plays the stored broadcast data when it takes a relatively short amount of time to play the broadcast data, which is stored when the driver is unable to view the received broadcast data, and plays the generated broadcast summary data when it takes a relatively longer amount of time to play the stored broadcast data.

In the broadcast receiving mode, the play control unit 109 decompresses video data when the video data, in the broadcast data received from the broadcast receiving unit 104, is compressed video data, changes video resolution of the video data of the received broadcast data displayed on a display screen, and delivers the changed video resolution of video data to a video output unit 110, by transforming the changed video resolution of video data, delivered via a color pre-processing. Also, the play control unit 109 decompresses the compressed audio data when audio data, in the received broadcast data, is compressed data, resamples the decompressed audio data, and delivers the decompressed audio data to an audio output unit 111 by eliminating a noise.

In the moving picture data play mode or in the moving picture summary data play mode, the play control unit 109 delivers video data to be played at a predetermined point of time to the video output unit 110 by using moving picture data or moving picture summary data selected by a user from moving picture data stored in the storage unit 108, and delivers audio data to the audio output unit 111. When a screen shut off signal is generated from the play control unit 109, the play control unit 109 does not deliver the video data to the video output unit 110. Also, the play control unit 109 delivers present play condition information to the determination unit 102.

The video output unit 110 outputs the delivered video data on the display screen once the video data is delivered from the play control unit 109.

In the moving picture play mode or the broadcast receiving mode, when the driver of the vehicle is unable to view the received broadcast data or the moving picture data currently playing, the video output unit 110 does not output video data according to the playing of the received broadcast data or the moving picture data currently playing on the display screen, since the video data is not delivered from the play control unit 109.

Subsequently, according to an embodiment of the present invention, in the broadcast receiving mode or the moving picture play mode, the moving picture playing system 100 of the present invention prevents the video data, from the received broadcast data or the played moving picture data, from being outputted on the display screen when the driver of the vehicle is unable to view the received broadcast data or the played moving picture data.

The audio output unit 111 outputs delivered audio data when the audio data of the moving picture data or the received broadcast data is delivered from the play control unit 109.

The input unit 112 receives, from the driver, various selections from menus to control operations of the moving picture playing system 100. The various menus are types of menus associated with a play for the received broadcast data or the stored moving picture data, for example, a moving picture selection menu, a moving picture play menu, a broadcast receiving menu, and a broadcast selection menu.

As described above, the moving picture playing system 100 shuts off the video data or the received broadcast data by detecting a vehicle condition, so that the driver of the vehicle is unable to view the video data or the received broadcast data during driving.

Thus, the moving picture playing system 100 prevents a vehicle accident from occurring due to the viewing the moving picture since the driver of the vehicle is unable to view the received broadcast data while driving.

Also, according to an embodiment of the present invention, the moving picture playing system 100 records and summarizes the received broadcast data while the driver is driving the vehicle, and automatically provides the driver with the recorded broadcast data or the summarized broadcast data, when the vehicle is not being driven.

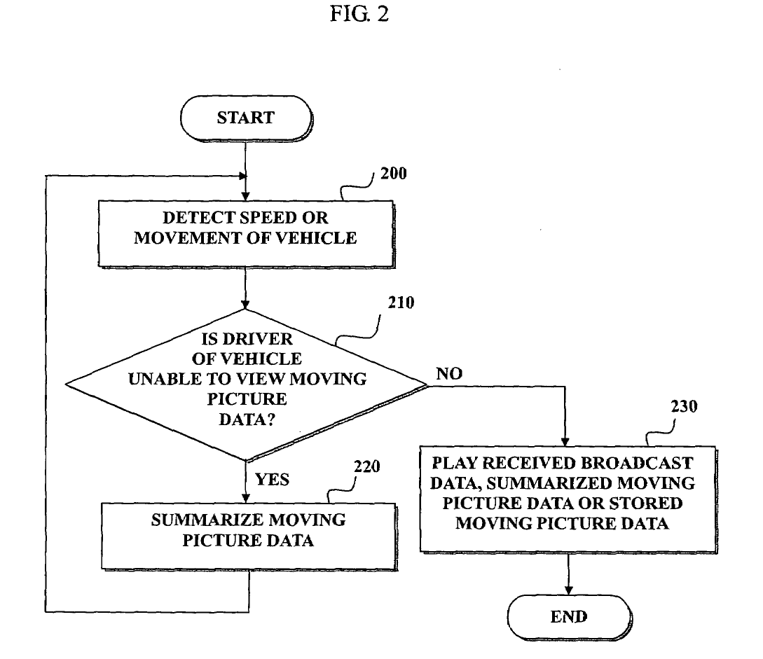

FIG. 2 is a flowchart illustrating a moving picture playing method according to another embodiment of the present invention.

In FIGS. 1 and 2, the moving picture playing system 100 detects speed or movement of the vehicle via the vehicle in the driving condition detection unit 101 in operation 200. From operation 200, the process moves to operation 210 where it is determined whether the driver of the vehicle is unable to view the moving picture data while the driver is driving the vehicle, based on the detected speed or movement of the vehicle via the determination unit 102 as detected in operation 200.

When it is determined the driver of the vehicle is unable to view the moving picture data in operation 210, the process moves to operation 220, where the moving picture playing system 100 summarizes the moving picture data via the summary unit 107.

For example, when the moving picture is broadcast data received from the broadcast receiving unit 104, and when it is determined the driver of the vehicle is unable to view the moving picture data via the determination unit 102 in operation 210, the process moves to operation 220 where the moving picture playing system 100 generates a summary generation start signal via the control signal generation unit 103, and summarizes the received broadcast data via the summary unit 107 according to the summary generation start signal.

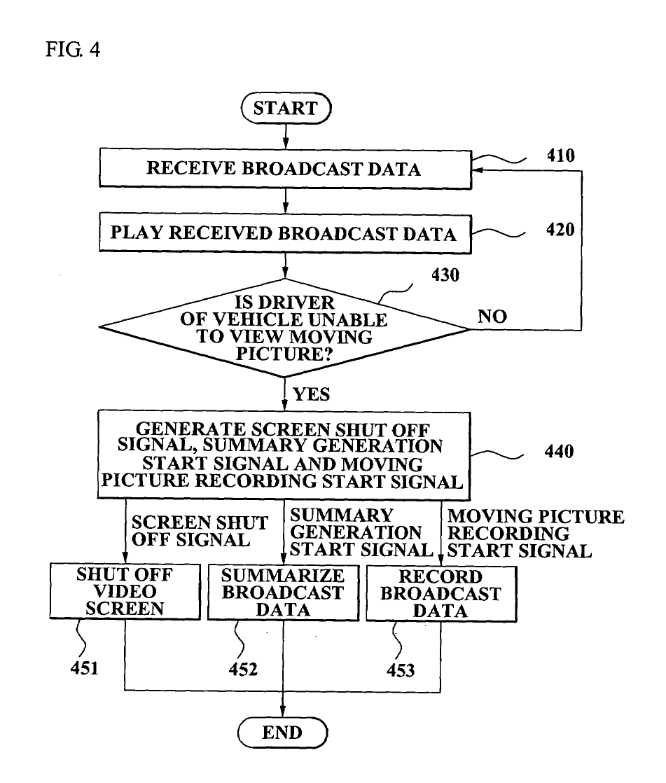

Also, when it is determined the driver of the vehicle is unable to view the moving picture data, the moving picture playing system 100 generates a screen shut off signal via the control signal generation unit 103 (see FIG. 4), and prevents video data from being delivered to the video output unit 110 via the play control unit 109 according to the screen shut off signal.

For example, when the moving picture data is the received broadcast data, and when it is determined that the driver of the vehicle is unable to view the received broadcast data, the moving picture playing system 100 generates a moving picture recording start signal via the control signal generation unit 103, and records and stores the received broadcast data in the storage unit 108 according to the moving picture recording start signal.

Also, when it is determined that the driver of the vehicle is able to view the moving picture data in operation 210, the process moves to operation 230, where the moving picture playing system 100 plays the received broadcast data, the summarized moving picture or the stored moving picture data.

For example, when it is determined that the driver of the vehicle is able to view the moving picture data, and the moving picture data is the broadcast data received from the broadcast receiving unit 104, the moving picture playing system 100 plays the received broadcast data via the play control unit 109.

In another example, when it is determined that the driver of the vehicle is able to view the moving picture data, and when the moving picture data is the summarized broadcast data, summarized when the driver is unable to view the moving picture data, which is stored in the storage unit 108, the moving picture playing system 100 plays the summarized broadcast data via the play control unit 109.

As described above, the moving picture playing method according to an embodiment of the present invention plays the summarized broadcast data or the recorded broadcast data when the driver of the vehicle is able to view the received broadcast data since the moving picture playing method prevents the delivery of moving picture data of the received broadcast data, and summarizes and records the received broadcast data when it is determined the driver of the vehicle is unable to view the received broadcast data.

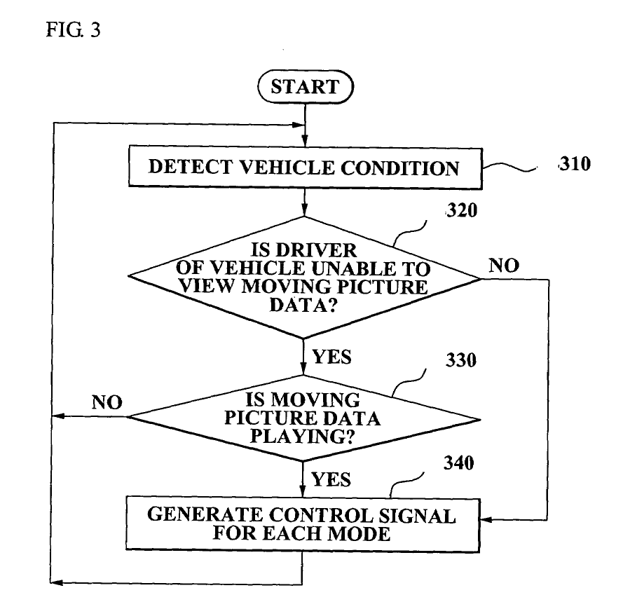

FIG. 3 is a flowchart illustrating operations of generating a control signal for each mode of the system shown in FIG. 1, according to an embodiment of the present invention.

Referring to FIGS. 1-3, the moving picture playing system 100 detects the vehicle condition via a vehicle condition detection unit 101 of FIG. 1, in operation 310. That is, the moving picture playing system 100 detects the speed or the movement of the vehicle via the vehicle condition detection unit 101.

From operation 310, the process moves to operation 320, where the moving picture playing system 100 compares the detected speed or the movement of the vehicle determined in operation 310, with a reference value, and when the detected speed or the movement of the vehicle is greater than the reference value, the moving picture playing system 100 determines the driver is unable to view the moving picture data via the determination unit 102, based on the speed or the movement of the vehicle detected via the vehicle condition detection unit 101.

In FIG. 1, as an example, when the detected speed of the vehicle is greater than the first reference value, the moving picture playing system 100 determines that the vehicle is being driven and determines that the driver is unable to view the moving picture data in operation 320.

As an another example, when the detected movement of the vehicle is greater than a second reference value, the moving picture playing system 100 determines that the vehicle is being driven and determines that the driver of the vehicle is unable to view the moving picture data in operation 320.

When it is determined that the driver of the vehicle is unable to view the moving picture data in operation 320, the process moves to operation 330, where it is determined whether the moving picture data is playing.

When it is determined that the moving picture data is playing in operation 330, or when it is determined the driver is able to view the moving picture in operation 320, the process moves to operation 340, where the moving picture playing system 100 generates a control signal for each mode via the control signal generation unit 103. The control signal for the each mode is a type of a control signal according to a moving picture play mode or a broadcast receiving mode.

For example, when the driver of the vehicle is unable to view the moving picture data, when the moving picture is playing, and when in the broadcast receiving mode, the moving picture playing system 100 generates a screen shut off signal, a broadcast recording start signal, and a summary generation start signal, using a control signal according to the broadcast receiving mode, via the control signal generation unit 103 in the operation 340.

In another example, when the driver of the vehicle is unable to view the moving picture data, and when in the moving picture play mode, the moving picture playing system 100 generates a screen shut off signal and a pause signal according to the moving picture play mode via the control signal generation unit 103 in the operation 340.

In yet another example, when the driver of the vehicle is able to view the moving picture data, and when in the moving picture play mode, the moving picture playing system 100 generates a recording stop signal, a summary play signal and a screen connection signal via the control signal generation unit 103 in operation 340.

In yet another example, when the driver of the vehicle is able to view the moving picture data, and when in the moving picture play mode, the moving picture playing system 100 generates a screen connection signal and a play signal via the control signal generation unit 103 in the operation 340.

When it is determined that the moving picture data is not playing, or after generating control signals for each mode, the moving picture playing system 100 repeatedly performs the above operations from operation 310.

As described above, according to aspects of the present invention, the moving picture playing method generates the control signals for the each mode, according to whether the driver is able to view the moving picture, and plays, records or summarizes the received broadcast data based upon the generated control signals for the each mode.

According to an embodiment of the present invention, the moving picture playing method provides the summarized broadcast data or the recorded broadcast data when the driver is not driving the vehicle since the received broadcast data is summarized or recorded when a screen of the moving picture is shut off and the driver is driving the vehicle.

FIG. 4 is a flowchart illustrating summarizing and recording operations when the driver is unable to view received broadcast data according to an embodiment of the present invention.

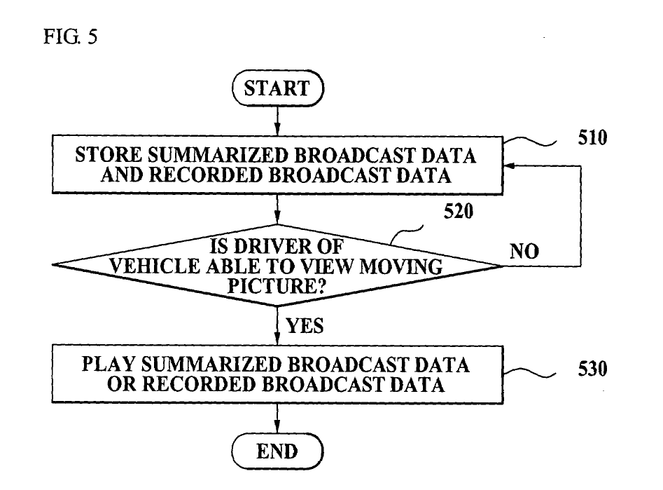

In FIGS. 4 and 5, in operation 410, the moving picture play system 100 receives broadcast data via the broadcast receiving unit 104 of FIG. 1 in operation 410.

From operation 410, the process moves to operation 420, where the moving picture play system 100 performs a play control for the received broadcast data via the play control unit 109 of FIG. 1, outputs video data of the received broadcast data to the video output unit 110 shown in FIG. 1, outputs audio data of the received broadcast data to the audio output unit 111 shown in FIG. 1, and thereby plays the received broadcast data.

From operation 420, the process moves to operation 430, where the moving picture play system 100 determines whether the driver of the vehicle is able to view a moving picture for the received broadcast data. That is, the moving picture play system 100 determines that the driver is unable to view the moving picture of the received broadcast data when a dangerous condition exists, such as a likelihood of a vehicle accident occurring, the driver views the moving picture for the received broadcast data without regard to a situation of car or a driver's condition.

When it is determined the driver of the vehicle is unable to view the moving picture of the received broadcast data in operation 430, the process moves to operation 440, where the moving picture play system 100 generates a screen shut off signal, a summary generation start signal, and a moving picture recording start signal via the control signal unit 103 shown in FIG. 1.

From operation 440, the process moves to operations 451-453. In operation 451, the moving picture play system 100 shuts off a video screen by preventing video data of the received broadcast data from being delivered to the video output unit 110, via the play control unit 109, according to the screen shut off signal. In this embodiment, the moving picture play system 100 may output only audio data to the audio output unit 111, without outputting video data.

As described above, according to an embodiment of present invention, the moving picture play method includes shutting off the video screen displaying the received broadcast data while the driver is driving the vehicle, in order to prevent a vehicular accident caused by viewing the moving picture for the received broadcast data while driving.

In operation 452, the moving picture play system 100 controls the summary unit 107 shown in FIG. 1 via the broadcast recording control unit 105 according to the summary generation start signal, summarizes the received broadcast data, and stores the summarized broadcast data in the storage unit 108.

As described above, according to an embodiment of the present invention, the moving picture play method includes providing the summarized broadcast data when the driver is not driving the vehicle by playing the summarized broadcast data since the received broadcast data is summarized even when the driver is unable to view the moving picture for the received broadcast data while the driver is driving the vehicle.

In operation 453, the moving picture play system 100 controls the compression unit 106 via the broadcast recording control unit 105, compresses the received broadcast data, and stores the compressed broadcast data, and records the received broadcast data according to the moving picture recording start signal.

As described above, according to an embodiment of the present invention, the moving picture play method includes providing the driver of the vehicle with the recorded broadcast data even when the driver is unable to view the received broadcast data while driving since the received broadcast data is recorded, and played when the driver is not driving the vehicle.

FIG. 5 is a flowchart illustrating playing operation of summarized broadcast data or recorded broadcast data according to an embodiment of the present invention.

In FIGS. 1-5, in operation 510 of FIG. 5, the moving picture playing system 100 stores the summarized broadcast data and the recorded broadcast data in the storage unit 108 when the driver of the vehicle is unable to view the moving picture of the received broadcast data in operation.

From operation 510, the process moves to operation 520, where the moving picture playing system 100 determines whether the driver is able to view the moving picture for the received broadcast data via the determination unit 102. That is, the moving picture playing system 100 determines whether the driver is able to view the moving picture for the received broadcast data according to a situation of vehicle or a driver's condition, via the determination unit 102 shown in FIG. 1. Specifically, the moving picture playing system 100 determines that the driver is able to view the moving picture of the received broadcast data while the vehicle is not being driven.

When it is determined the driver is able to view the moving picture of the received broadcast data in operation 520, the process moves to operation 530, where the moving picture playing system 100 plays the summarized broadcast data or the recorded broadcast data.

According to an embodiment of the present invention, the moving picture playing system 100 plays the recorded broadcast data by comparing a length of the recorded broadcast data with a reference value, and when the length of the recorded broadcast data is less than the reference value the moving picture playing system 100 plays the recorded broadcast data. For example, when the reference value is thirty seconds, and when the length of the recorded broadcast data is less than thirty seconds, the moving picture playing system 100 plays the recorded broadcast data since the length of the recorded broadcast data is less than the reference value. The present invention is not limited to any particular preset time for the reference value, and may vary accordingly.

According to another embodiment of the present invention, the moving picture playing system 100 plays the summarized broadcast data by comparing the length of the recorded broadcast data with the reference value, and when the length of the recorded broadcast data is greater than the reference value in the operation 530, the moving picture playing system 100 plays the summarized broadcast data. Further, when the reference value is thirty seconds, for example, and when the length of the recorded broadcast data is greater than thirty seconds, the moving picture playing system 100 plays the summarized broadcast data, instead of the recorded broadcast data, since the length of the summarized broadcast data is shorter than the reference value in the operation 530.

As described above, according to an embodiment of the present invention, the moving picture play method includes storing the summarized broadcast data and the recorded broadcast data when the driver of the vehicle is unable to view the moving picture for the received broadcast data, and plays the summarized broadcast data or the recorded broadcast data when the driver of the vehicle is able to view the moving picture for the received broadcast data, therefore the driver may view the broadcast data that the driver was unable to view while driving due to the likelihood of the vehicle accident.

The moving picture play method according to the above-described embodiment of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, and the like, including a carrier wave transmitting signals specifying the program instructions, data structures, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

According to an embodiment of the present invention, there is provided a moving picture play method and a moving picture play system which can shut off video data for viewing moving picture which might cause a vehicle accident when a driver of the vehicle views the moving picture while driving, and exclusively output audio data.

Also, according to the present invention, there is provided a moving picture play method and a moving picture play system which can play recorded moving picture data or summarized moving picture data only in safe viewing circumstances since whether a driver of a vehicle is able to view the moving picture data is determined by detecting speed or movement of the vehicle.

Also, according to the present invention, there is provided a moving picture play method and a moving picture play system which can automatically play recorded broadcast data when a vehicle is not being driven, by recording received broadcast data during driving, the recording the received broadcast data preventing missing a major scene of the broadcast since as a result of the moving picture has been shut off while a driver is driving the vehicle.

Although a few embodiments of the present invention have been shown and described, it would be appreciated by those skilled in the art that changes may be made to these embodiments without departing from the principles and spirit of the invention, the scope of which is defined by the claims and their equivalents.

What is claimed is:

1. A moving picture playing method used in a vehicle, the method comprising:
determining whether a driver of a vehicle is unable to view moving picture data;
summarizing moving picture data when it is determined that the driver of the vehicle is unable to view the moving picture data; and
playing the summarized moving picture data or recorded moving picture data, when it is determined that the driver of the vehicle is able to view moving picture data.

2. The method of claim 1, wherein the summarizing moving picture data comprises:
generating a screen shut off signal and a summary generation start signal for the moving picture data, when it is determined that the driver of the vehicle is unable to view the moving picture data;
preventing video data of the moving picture data from being outputted on the display screen according to the screen shut off signal; and
generating summary data for the moving picture data according to the summary generation start signal.

3. The method of claim 1, wherein the determining whether a driver of a vehicle is unable to view moving picture data comprises:
detecting a vehicle condition; and
determining whether the driver of the vehicle is unable to view the moving picture based on the detected vehicle condition.

4. The method of claim 3, wherein the detecting a vehicle condition comprises:
detecting speed and/or movement of the vehicle, and
the determining whether the driver of the vehicle is unable to view the moving picture comprises:
determining that the driver of the vehicle is unable to view the moving picture data when the detected speed and/or movement of the vehicle is greater than a reference value by comparing the detected speed and/or movement of the vehicle with the reference value.

5. The method of claim 1, wherein the summarizing moving picture data comprises:
recording received broadcast data when the moving picture is the received broadcast data, and when the driver of the vehicle is unable to view the received broadcast data; and
summarizing the received broadcast data.

6. The method of claim 1, wherein the playing the summarized moving picture data or recorded moving picture data comprises:
determining whether a length of the recorded broadcast data is less than a reference value when it is determined the driver of the vehicle is able to view the moving picture data; and
playing the recorded broadcast data when the length of the recorded broadcast data is less than the reference value.

7. The method of claim 6, wherein the playing the summarized moving picture data or recorded moving picture data comprises:
playing the summarized moving picture data when the length of the recorded broadcast data is not less than the reference value.

8. A computer-readable storage medium storing a program for implementing a method of playing a moving picture in a vehicle performed by a computer, the method comprising:
determining whether a driver of a vehicle is unable to watch moving picture data;
summarizing moving picture data when it is determined that the driver of the vehicle is unable to watch the moving picture data; and
playing the summarized moving picture data or recorded moving picture data when it is determined that the driver of the vehicle is able to watch moving picture data.

9. A system of playing a moving picture, the system comprising:
a vehicle condition detection unit to detect a vehicle condition;
a play unit to play broadcast data or moving picture data;
a determination unit to determine whether a driver of the vehicle is unable to view the played broadcast data or moving picture data based on the detected vehicle condition; and
a summary unit to summarize the received broadcast data or moving picture data when it is determined that the driver of the vehicle is unable to view the moving picture.

10. The system of claim 9, further comprising:
a control signal generation unit to generate a screen shut off signal, a moving picture recording start signal, and a summary generation start control signal when it is determined that the driver of the vehicle is unable to view the moving picture data;
a video output unit to prevent a screen output of a video data of the received broadcast data according to the screen shut off signal; and
a storage unit to store recorded broadcast data according to the moving picture recording start signal, and the summarized broadcast data via the summary unit according to the summary generation start control signal.

11. The system of claim 9, wherein the vehicle condition detection unit detects speed and/or movement of the vehicle, and
the determination unit determines the driver of the vehicle is unable to view the moving picture when the detected speed and/or movement of the vehicle is greater than a reference value by comparing the detected speed and/or movement of the vehicle with a reference value.

12. The system of claim 10, wherein the determination unit determines whether a length of the recorded moving picture data is less than the reference value when it is determined the driver of the vehicle is able to view the moving picture, and
the play unit plays the recorded moving picture data when the length of the recorded moving picture data is less than the reference value.

13. The system of claim 12, wherein the play unit plays the summarized broadcast data when the length of the recorded broadcast data is not less than the reference value.

14. The system of claim 9, wherein the summary unit summarizes the received broadcast data while the driver is driving the vehicle, and the summarized broadcast data is played when the driver is not driving the vehicle.

15. The system of claim 10, further comprising an audio output unit, wherein when the shut off signal is generated to prevent the screen output of the video data of the received broadcast data, audio data is outputted from the audio output unit without the outputting of video data.
